(19) United States
(12) Patent Application Publication
(10) Pub. No.: US 2010/0291776 A1
(43) Pub. Date: Nov. 18, 2010

(54) Board-To-Board Connector Assembly

(76) Inventors: Sheng-Yuan Huang, Tu-Cheng City (TW); Yung-Chi Peng, Tu-Cheng City (TW)

Correspondence Address: LIN & ASSOCIATES INTELLECTUAL PROPERTY, INC., P.O. BOX 2339, SARATOGA, CA, 95070-0339, US

(21) Appl. No.: 12/464,871

(22) Filed: May 13, 2009

(51) Int. Cl. H01R 12/00

(52) U.S. Cl. 439/74

(57) ABSTRACT

A board-to-board connector assembly includes a receptacle connector having a plurality of first terminals, and a plug connector having a plurality of second terminals. Each of the first terminals has an elastic arm oppositely defining two first contact portions, and a first contact arm spaced away from the elastic arm. Each of the second terminals has a second contact arm defining two opposite contact means, and a third contact arm defining a second contact portion towards the second contact arm. When the plug connector is mated with the receptacle connector, the elastic arm of the first terminal is disposed between the second and third contact arms of the corresponding second terminal to make the two first contact portions electrically contact one of the two contact means and the second contact portion respectively, and the first contact arm electrically abuts against the other contact means.

### BACKGROUND OF THE INVENTION

1. Field of the Invention

The present invention generally relates to an electrical connector, and more particularly to a board-to-board connector assembly.

2. The Related Art

A conventional board-to-board connector assembly includes a receptacle connector and a plug connector. The receptacle connector has a plurality of receptacle terminals each having a contact portion, and the plug connector has a plurality of plug terminals each having a contact arm. When the plug connector is mated with the receptacle connector, the contact portion electrically contact the corresponding contact arm to make the receptacle terminal and the corresponding plug terminal electrically interconnected. However, the receptacle terminal contacts the corresponding plug terminal merely in one single point. As a result, when the board-to-board connector assembly is shaken in use, the contact portion is likely to depart from the corresponding contact arm that makes signal transmission between the receptacle terminal and the corresponding plug terminal broken easily. Therefore, a board-to-board connector assembly capable of overcoming the above-mentioned problems is required.

### SUMMARY OF THE INVENTION

An object of the present invention is to provide a board-to-board connector assembly including a receptacle connector and a plug connector. The receptacle connector includes a receptacle housing defining a plurality of first passageways and a plurality of first terminals received in the respective first passageways. Each of the first terminals has a first base portion located in a bottom of the receptacle housing, an elastic arm extending upward from the first base portion and a first contact arm spaced away from the elastic arm. The elastic arm oppositely defines two first contact portions. The plug connector is mated with the receptacle connector, and includes a plug housing defining a plurality of second passageways and a plurality of second terminals received in the respective second passageways. Each of the second terminals has a second base portion located in a top of the plug housing. The second base portion extends downward to form a second contact arm and a third contact arm spaced away from each other. The second contact arm defines a first contact means facing the third contact arm and a second contact means opposite to the first contact means. The third contact arm defines a second contact portion towards the second contact arm. Wherein the elastic arm of the first terminal is disposed between the second and third contact arms of the corresponding second terminal to make the first contact portions electrically contact the first contact means and the second contact portion respectively, the first contact arm electrically abuts against the second contact means. Such that ensures the first terminal and the corresponding second terminal electrically connected with each other steadily even if the board-to-board connector assembly is shaken in use.

### BRIEF DESCRIPTION OF THE DRAWINGS

The present invention will be apparent to those skilled in the art by reading the following description, with reference to the attached drawings, in which:

FIG. 1 is a perspective view of a board-to-board connector assembly in accordance with the present invention;

FIG. 2 is an exploded perspective view of the board-to-board connector assembly of FIG. 1;

FIG. 3 is a cutaway perspective view of a receptacle housing of a receptacle connector of the board-to-board connector assembly of FIG. 1;

FIG. 4 is a perspective view of a first terminal of the receptacle connector of the board-to-board connector assembly of FIG. 1;

FIG. 5 is a perspective view of a plug housing of a plug connector of the board-to-board connector assembly of FIG. 1;

FIG. 6 is a cutaway perspective view of the plug housing of FIG. 5;

FIG. 7 is a perspective view of a second terminal of the plug connector of the board-to-board connector assembly of FIG. 1; and

FIG. 8 is a cross-sectional view of the board-to-board connector assembly along line VIII-VIII of FIG. 1.

### DETAILED DESCRIPTION OF THE PREFERRED EMBODIMENT

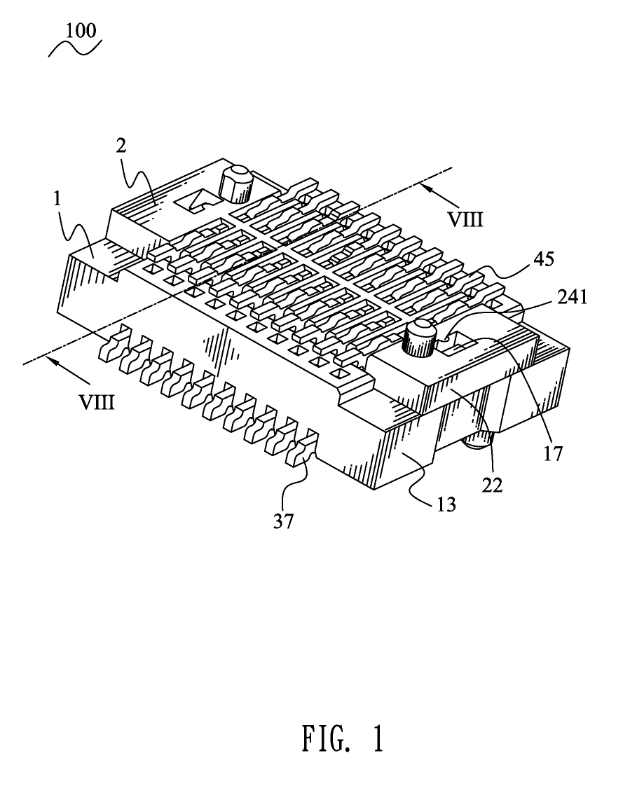

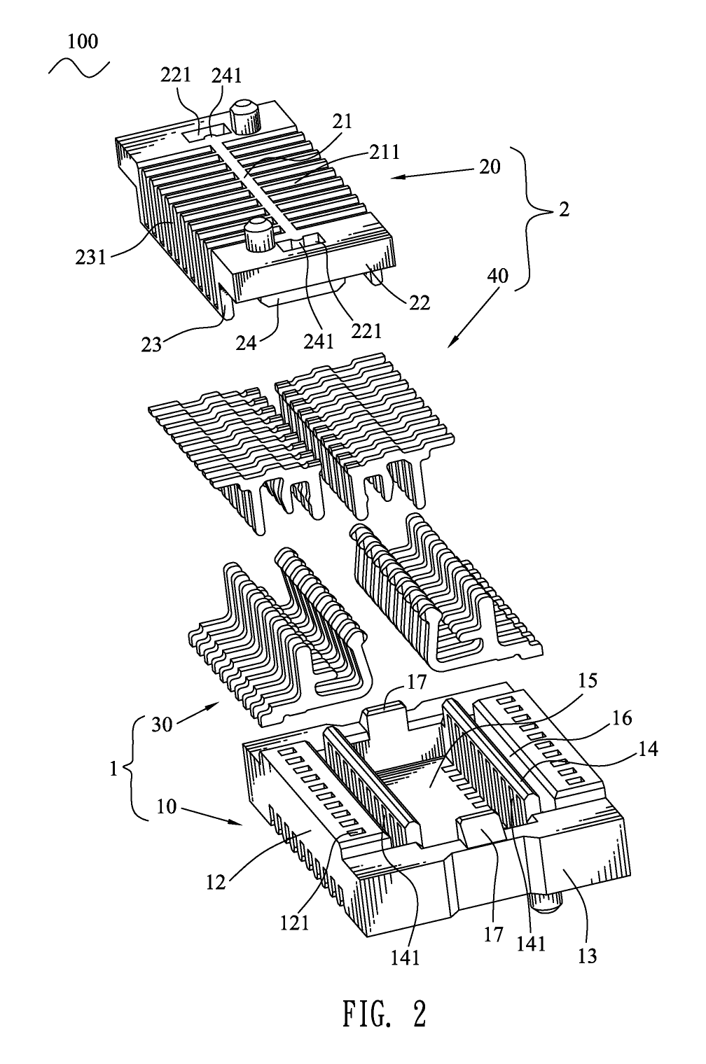

With reference to FIG. 1 and FIG. 2, a board-to-board connector assembly 100 in accordance with the present invention includes a receptacle connector 1 and a plug connector 2 mated with the receptacle connector 1.

Referring to FIG. 2, the receptacle connector 1 includes a receptacle housing 10 and a plurality of first terminals 30 disposed in the receptacle housing 10 respectively.

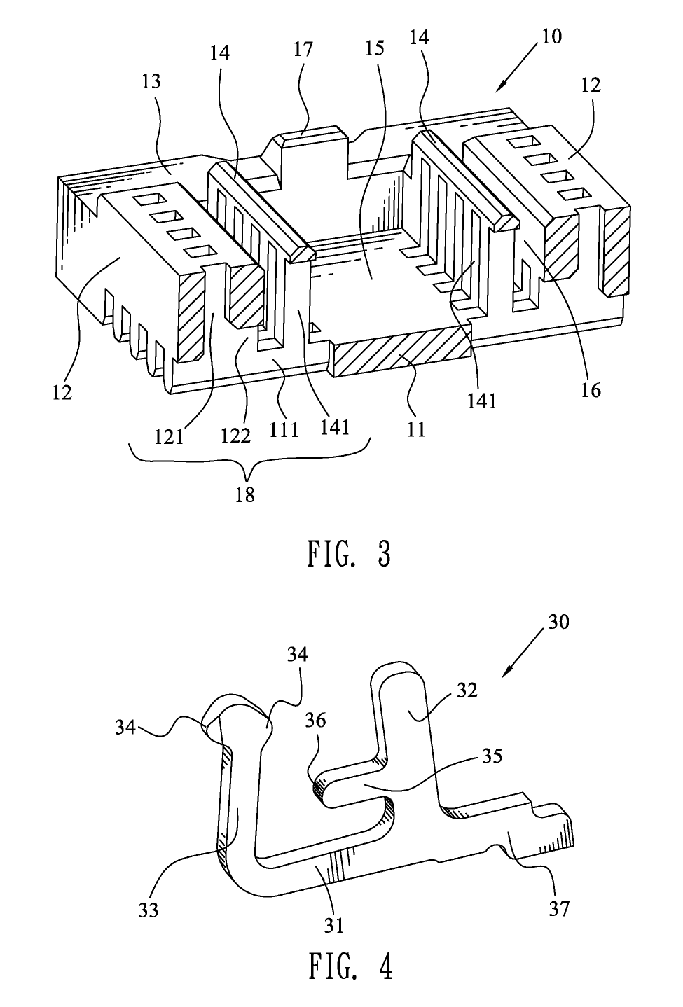

Referring to FIG. 2 and FIG. 3, the receptacle housing 10 has a rectangular flat base board 11. Two opposite sides of the base board 11 extend upward to form a pair of sidewalls 12 extending longwise. Two opposite ends of the base board 11 extend upward to form a pair of first end-walls 13 connected with the sidewalls 12. The base board 11 further extends upward to form two inserting boards 14 which extend longwise between the two sidewalls 12 and are respectively adjacent to the corresponding sidewalls 12. Two opposite ends of each of the inserting boards 14 are connected with the corresponding first end-walls 13. So a receiving recess 15 is formed among the inserting boards 14 and the first end-walls 13, and two receiving spaces 16 are respectively formed among the inserting boards 14, the corresponding sidewalls 12 and the first end-walls 13. A middle of each of the first end-walls 13 protrudes upward to form a right-trapezoid guiding block 17, of which a vertical surface opposite to an inclined surface is located in the same plane with an inside surface of the corresponding first end-wall 13.

In FIG. 3, each of the inserting boards 14 defines a plurality of first receiving cavities 141 arranged at regular intervals along a longwise direction thereof and penetrating therethrough to communicate with the receiving recess 15 and the corresponding receiving space 16. Each of the sidewalls 12 defines a plurality of first fixing perforations 121 vertically passing therethrough and corresponding to the first receiving cavities 141. A bottom of the first fixing perforation 121 further extends towards the corresponding first receiving cavity 141 and passes through the respective sidewall 12 to form a receiving fillister 122 communicating with the receiving space 16. Two sides of the base board 11 define a plurality of first receiving grooves 111 connecting the first receiving cavities 141 and the corresponding first fixing perforations 121 and further communicating with the corresponding receiving fillister 122. The first receiving groove 111, the first fixing perforation 121, the receiving fillister 122 and the first receiving cavity 141 together define a first passageway 18.

Referring to FIG. 4, each of the first terminals 30 has a bar-shaped first base portion 31. Two opposite ends of the first base portion 31 extend towards a same direction perpendicular to the first base portion 31 to respectively form a first fixing arm 32 and an elastic arm 33 inclined towards the first fixing arm 32. A free end of the elastic arm 33 protrudes oppositely to form two first contact portions 34, one of which faces the first fixing arm 32 and the other is opposite to the first fixing arm 32. The first fixing arm 32 protrudes towards the elastic arm 33 to form a first contact arm 35 having an arc contact end 36. One end of the first base portion 31 further extends to form a first soldering portion 37 perpendicularly adjacent to the first fixing arm 32.

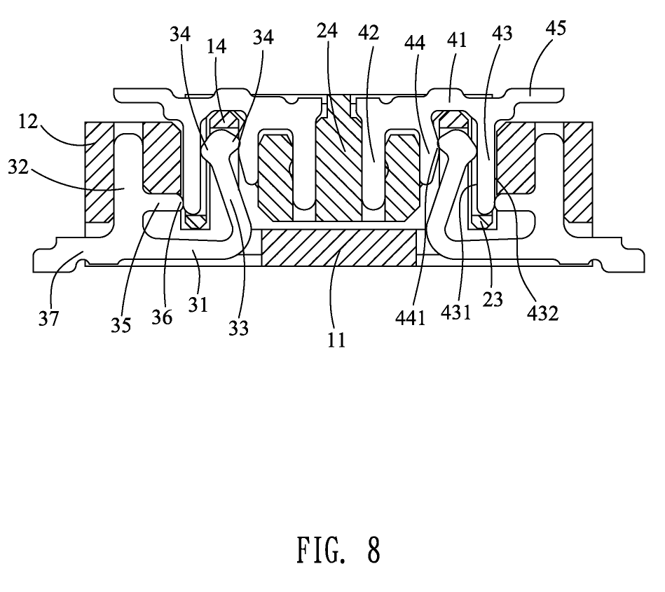

Referring to FIG. 8, when the receptacle connector 1 is to be assembled, the first terminals 30 are received in the respective first passageways 18 of the receptacle housing 10. The first base portion 31 is disposed in the first receiving groove 111. The first fixing arm 32 is inserted in the first fixing perforation 121. The first contact arm 35 is received in the receiving fillister 122 and the contact end 36 stretches into the corresponding receiving space 16. The elastic arm 33 is received in the first receiving cavity 141 and the two first contact portions 34 respectively stretch into the receiving recess 15 and the corresponding receiving space 16. The first soldering portion 37 stretches out of the corresponding sidewall 12.

Referring to FIG. 2 again, the plug connector 2 includes a plug housing 20 mated with the receptacle housing 10 and a plurality of second terminals 40 disposed in the plug housing 20 respectively.

Referring to FIGS. 2, 5 and 6, the plug housing 20 has a rectangular flat base plate 21. Two opposite ends of the base plate 21 slightly protrude downward to form a pair of second end-walls 22. Two opposite sides of the base plate 21 extend downward to form a pair of side plates 23 each extending longwise to connect the two second end-walls 22. A middle of the base plate 21 extends downward to form a rectangular inserting wall 24 extending longwise to connect the two second end-walls 22. The side plates 23 and the inserting wall 24 are higher than the two second end-walls 22. Accordingly, two receiving channels 25 are formed between the inserting wall 24 and the corresponding side plates 23. A middle of each of the second end-walls 22 defines a right-trapezoid guiding hole 221 vertically passing therethrough. A vertical side opposite to an inclined side of each of the guiding holes 221 is adjacent to a corresponding end surface of the inserting wall 24. A middle of each end surface of the inserting wall 24 protrudes outward into the corresponding guiding hole 221 to form a propping bar 241 of semi-cylinder shape extending vertically.

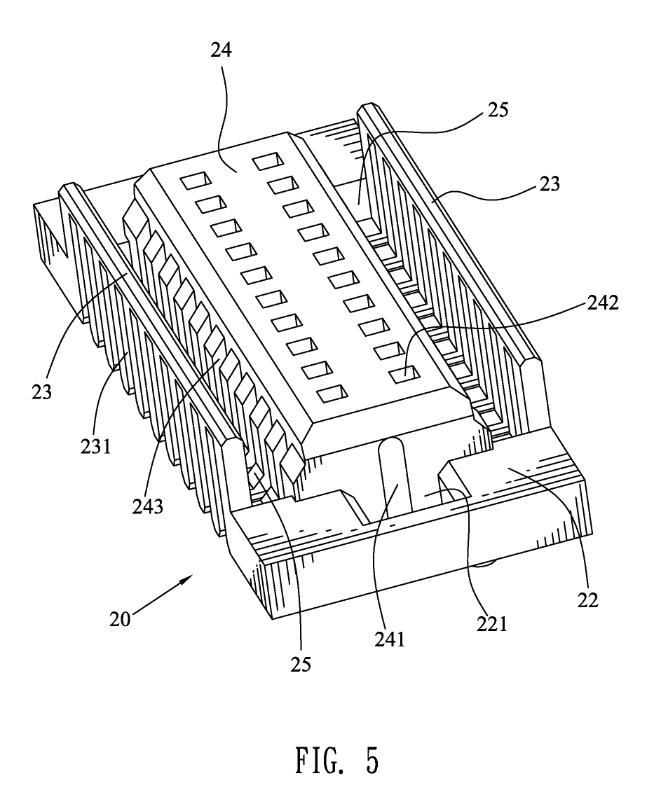

In FIG. 5 and FIG. 6, each of the side plates 23 define a plurality of second receiving cavities 231 arranged at regular intervals along a longwise direction thereof and penetrating therethrough to communicate with the corresponding receiving channel 25 and the outside. The inserting wall 24 defines two rows of second fixing perforations 242 corresponding to the second receiving cavities 231 and each vertically passing therethrough. Two opposite sides of the inserting wall 24 further define a plurality of receiving trenches 243 communicating with the corresponding receiving channels 25 and corresponding to the second receiving cavities 231 and the second fixing perforations 242. Two sides of the base plate 21 define a plurality of second receiving grooves 211 each connecting the second receiving cavity 231, the corresponding receiving trench 243 and the corresponding second fixing perforation 242. The second receiving groove 211, the second fixing perforation 242, the receiving trench 243 and the second receiving cavity 231 together define a second passageway 26.

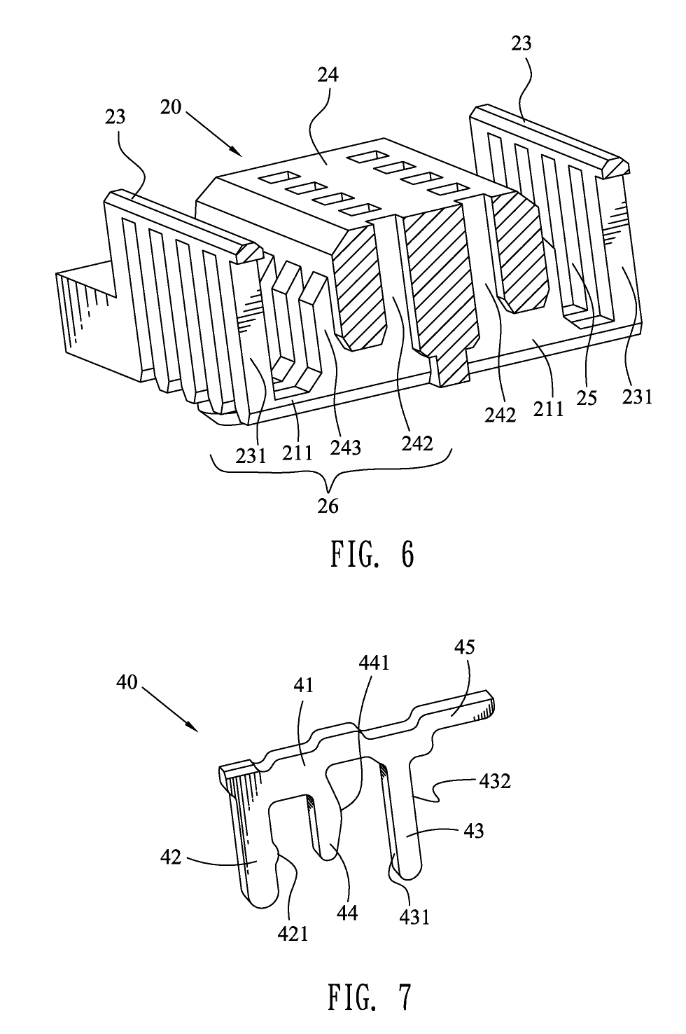

Referring to FIG. 7, each of the second terminals 40 has a bar-shaped second base portion 41. One end of the second base portion 41 extends towards a direction perpendicular to the second base portion 41 to form a second fixing arm 42 and the other end thereof further extends to form a second soldering portion 45. The second base portion 41 further extends towards the same direction with the second fixing arm 42 to form a second contact arm 43 and a third contact arm 44 spaced away from each other. The second contact arm 43 is located perpendicularly adjacent to the second soldering portion 45 and defines a first contact surface 431 facing the third contact arm 44 and a second contact surface 432 opposite to the first contact surface 431. The third contact arm 44 is substantially located at a middle of the second base portion 41 and has a middle protruded towards the second contact arm 43 to form an arc second contact portion 441. The second fixing arm 42 protrudes towards the third contact arm 44 to form a fixing bump 421.

Referring to FIG. 8 again, when the plug connector 2 is to be assembled, the second terminals 40 are received in the respective second passageways 26 of the plug housing 20. The second base portion 41 is disposed in the second receiving groove 211. The second fixing arm 42 is inserted in the second fixing perforation 242 and the fixing bump 421 abuts against an inner of the corresponding second fixing perforation 242. The second contact arm 43 is received in the second receiving cavity 231. The third contact arm 44 is received in the receiving trench 243 and the second contact portion 441 stretches into the corresponding receiving channel 25. The second soldering portion 45 stretches out of the corresponding side plate 23.

Referring to FIGS. 1 and 8 again, when the plug connector 2 is engaged with the receptacle connector 1, the inserting wall 24 of the plug housing 20 is received in the receiving recess 15 of the receptacle housing 10, the side plates 23 are inserted in the corresponding receiving spaces 16, and the inserting boards 14 of the receptacle housing 10 are inserted in the corresponding receiving channels 25 of the plug housing 20. The elastic arm 33 of the first terminal 30 is inserted between the second contact arm 43 and the third contact arm 44 of the corresponding second terminal 40 to make the first contact portions 34 tightly electrically contact the second contact portion 441 and the first contact surface 431 respectively. The contact end 36 electrically abuts against the second contact surface 432. So that ensures the first terminal 30 and the corresponding second terminal 40 electrically connected with each other steadily. Moreover, the guiding block 17 of the receptacle housing 10 is inserted into the corresponding guiding hole 221 of the plug housing 20, and the propping bar 241 abuts against the vertical surface of the corresponding guiding block 17 and the inside surface of the corresponding first end-wall 13. Each of the second end-walls 22 is located on the corresponding first end-wall 13. Therefore, the plug connector 2 can be rightly and firmly engaged with the receptacle connector 1 so that further ensures a steady electrical connection between the first terminal 30 and the corresponding second terminal 40.

As described above, the first contact portions 34 of the first terminal 30 are clipped between the second and third contact arms 43, 44 of the corresponding second terminal 40 so as to tightly electrically contact the first contact surface 431 and the second contact portion 441 respectively, and furthermore, the first terminal 30 further utilizes the contact end 36 to electrically abut against the second contact surface 432 of the corresponding second terminal 40. Such that ensures the first terminal 30 and the corresponding second terminal 40 electrically connected with each other steadily even if the board-to-board connector assembly 100 is shaken in use.

What is claimed is:

1. A board-to-board connector assembly, comprising:
a receptacle connector having
a receptacle housing defining a plurality of first passageways, and
a plurality of first terminals received in the respective first passageways and each having a first base portion located in a bottom of the receptacle housing, an elastic arm extending upward from the first base portion and a first contact arm spaced away from the elastic arm, the elastic arm oppositely defining two first contact portions; and
a plug connector mated with the receptacle connector and having
a plug housing defining a plurality of second passageways, and
a plurality of second terminals received in the respective second passageways and each having a second base portion located in a top of the plug housing, the second base portion extending downward to form a second contact arm and a third contact arm spaced away from each other, the second contact arm defining a first contact means facing the third contact arm and a second contact means opposite to the first contact means, the third contact arm defining a second contact portion towards the second contact arm;
wherein the elastic arm of the first terminal is disposed between the second and third contact arms of the corresponding second terminal to make the first contact portions electrically contact the first contact means and the second contact portion respectively, the first contact arm electrically abuts against the second contact means.

2. The board-to-board connector assembly as claimed in claim 1, wherein the two first contact portions are formed by oppositely protruding from a free end of the elastic arm, the first and second contact means are respectively a first contact surface and a second contact surface defined on the opposite sides of the second contact arm, the second contact portion is formed by protruding towards the second contact arm from the third contact arm.

3. The board-to-board connector assembly as claimed in claim 1, wherein the first base portion further extends upward to form a first fixing arm, the first contact arm is formed by protruding towards the elastic arm from the first fixing arm, a free end of the first contact arm is defined as a contact end electrically abutting against the second contact means.

4. The board-to-board connector assembly as claimed in claim 3, wherein one end of the first base portion further extends to form a first soldering portion adjacent to the first fixing arm and stretching out of the receptacle housing, the elastic arm is defined at the other end of the first base portion and inclined toward the first fixing arm.

5. The board-to-board connector assembly as claimed in claim 1, wherein one end of the second base portion extends downward to form a second fixing arm and the other end thereof further extends to form a second soldering portion stretching out of the plug housing, the second contact arm is located adjacent to the second soldering portion, and the third contact arm is located between the second contact arm and the second fixing arm.

6. The board-to-board connector assembly as claimed in claim 1, wherein the receptacle housing has a base board, two opposite sides of the base board extend upward to form a pair of sidewalls, the base board further extends upward to form two inserting boards paralleling the sidewalls and spaced away from each other, a receiving recess is formed between the inserting boards, and two receiving spaces are formed between the inserting boards and the corresponding sidewalls.

7. The board-to-board connector assembly as claimed in claim 6, wherein the plug housing has a base plate, two opposite sides of the base plate extend downward to form a pair of side plates inserted in the corresponding receiving spaces, the base plate further extends downward to form an inserting wall paralleling the side plates and received in the receiving recess, two receiving channels are formed between the inserting wall and the corresponding side plates for receiving the corresponding inserting boards of the receptacle housing therein.

8. The board-to-board connector assembly as claimed in claim 7, wherein each of the first passageways includes a first receiving cavity defined in the inserting board and communicating with the receiving recess and the corresponding receiving space for receiving the elastic arm therein, a receiving fillister defined in the sidewall and communicating with the corresponding receiving space for receiving the first contact arm therein, and a first receiving groove defined in the base board to connect the first receiving cavity and the receiving fillister for receiving the first base portion therein.

9. The board-to-board connector assembly as claimed in claim 7, wherein each of the second passageways has a second receiving cavity defined in the side plate and communicating with the corresponding receiving channel and the outside for receiving the second contact arm therein, a receiving trench defined in an outside of the inserting wall for receiving the third contact arm therein, and a second receiving groove defined in the base plate to connect the second receiving cavity and the receiving trench for receiving the second base portion therein.

10. The board-to-board connector assembly as claimed in claim 7, wherein two opposite ends of the base board extend upward to form two first end-walls connecting the sidewalls and the inserting boards, each of the first end-walls protrudes upward to form a guiding block, two opposite ends of the base plate extends downward to form two second end-walls connecting the inserting wall and the side plates, each of the second end-walls defines a guiding hole, the guiding block is inserted into the corresponding guiding hole and the second end-wall is located on the corresponding first end-wall.

11. The board-to-board connector assembly as claimed in claim 10, wherein each of the guiding blocks is of right-trapezoid shape and a vertical surface opposite to an inclined surface thereof is located in the same plane with an inside surface of the corresponding first end-wall, each of the guiding holes is of right-trapezoid shape and a vertical side opposite to an inclined side thereof is adjacent to a corresponding end surface of the inserting wall.

12. The board-to-board connector assembly as claimed in claim 11, wherein each end surface of the inserting wall protrudes into the corresponding guiding hole to form a propping bar abutting against the vertical surface of the corresponding guiding block and the inside surface of the corresponding first end-wall.
